(19) United States
(12) Patent Application Publication
(10) Pub. No.: US 2005/0117149 A1
(43) Pub. Date: Jun. 2, 2005

(54) Product testing apparatus

(76) Inventors: Herbert Grindinger, Muhldorf a. Inn (DE); Helmut Neusser, Parsdorf (DE); Nikolaus Seidenader, Munich (DE); Volker Wedershoven, Munich (DE)

Correspondence Address: DILWORTH & BARRESE, LLP, 333 EARLE OVINGTON BLVD., UNIONDALE, NY, 11553, US

(21) Appl. No.: 10/928,433

(22) Filed: Aug. 27, 2004

(30) Foreign Application Priority Data
Aug. 27, 2003 (DE) 10339473.7

(51) Int. Cl. G01N 21/88

(52) U.S. Cl. 356/239.4

(57) ABSTRACT

The present invention relates to an apparatus for testing products, especially ampules, bottles, and the like, with means for moving the products to be tested, with recording means for recording light beams or other signals characteristic of the products, and with a deflection or reflection means by which the light beams or other signals characteristic of the products can be deflected or reflected toward the recording means over at least a partial section of the motion of the products.

The present invention relates to an apparatus for testing products, especially ampules, bottles, and the like. Inspection apparatuses of this kind are used, for example, in the pharmaceutical industry, to test whether ampules, small bottles, etc. or even their contents meet specified qualitative and/or quantitative requirements. The test can relate, for example, to whether all the small bottles are sealed with caps according to specifications, whether and what markings or labels are present, whether the small bottles, ampules, etc. are damaged, and so forth. Moreover, tests can be performed as to whether the contents of such containers meet specified requirements in terms of consistency, quantity, color, etc. In addition, the dimensions and quality of the glass used in such containers can be tested, for example, whether cracks or other defects are present. The invention relates to an apparatus by means of which any kind of product, including solid, gaseous, or liquid products, can be tested. Notable examples are any sort of containers or products of the pharmaceuticals industry, the vitamin industry, the chemical industry, or, for instance, the food and beverage industry.

Apparatuses of the prior art for testing products such as ampules, etc., have a live ring that features a large number of receptacles for the ampules to be tested. The live ring has a camera tower near its rotational axis, on which one or generally several cameras are mounted. The cameras serve to optically record the products to be tested. Then an analysis unit examines whether the products meet the requirements or must be rejected.

The camera tower is designed to rotate around a certain pivoting angle, so that a camera that has fixed on an ampule to be tested is swung around with the ampule across a certain swivelling range. During this swivelling motion, it can be provided in inspection devices of the prior art that the ampule to be tested rotates once around its own axis so that its entire circumference can be inspected. For this purpose, it is provided that the receptacles of the live ring are furnished with rotary tables that cause the ampules to rotate.

If needed, it can also be provided that the ampules are made to rotate or shake prior to the actual recording, in order to test whether particles are present in a liquid. Meanwhile, it is provided that any rotation of the ampules around their own axis is stopped during the recording by the camera.

Both of the variants described above have in common that the camera tower is swung around with the ampules, small bottles, and the like, across a predefined arc, so that the optical recording of the ampule can be performed for a predefined period of time while it is moving along with the live ring.

Once the observation of one ampule is finished, the camera tower is swung back and the optical recording of another ampule is begun. Meanwhile, the camera is swung once again with the new ampule until the recording of that ampule is finished. The aforementioned process is repeated in devices of the prior art up to 400 times per minute. Due to the considerable weight of the camera tower, such oscillation requires a correspondingly large drive mechanism, can result in manifestations of wear under some circumstances, and also requires a stable and, under some circumstances, heavy construction. The oscillation of the camera tower can cause noise that may be unpleasant. Another problem can result from the fact that the power cables for the cameras may loosen with such high-frequency oscillation under some circumstances, leading to the need to fasten them specially.

The task of the present invention is to further develop an apparatus for testing products of the kind designated initially, in such a way that the oscillation of recording means, especially cameras, for recording products that move across a partial distance is not necessarily required.

This task is solved by a product testing apparatus according to Patent claim 1. Advantageous further developments of the invention form the subject matter of the dependent claims. The apparatus according to the invention has means for moving the products to be tested, as well as recording means for recording light signals or other signals that are characteristic of the products. In addition, a movable deflection or reflection means is provided by which the light beams or other signals characteristic of the products can be deflected or reflected toward the recording means during at least a partial distance of the motion of the products. The deflection or reflection means will be moved accordingly during at least a partial distance of the motion of the products, so that the products can be tested using the recording means during this partial distance of the motion. The deflection or reflection means conveys the light beams or any other signals emitted from the products to be tested toward the recording means, for example, the camera, during the motion of the products. Once the observation of one product, for example, an ampule, is finished, the deflection or reflection means can be moved back, and the observation of the next sample can be begun.

In contrast to the prior art outlined above, it is thus not necessarily required for a camera tower to be moved in a such a way that it repeatedly follows the products to be tested. According to the invention, it suffices if only the deflection or reflection means is moved in such a way, while the recording means, for example the cameras, can be mounted so as not to move. This achieves the advantage that the mechanical stressing of sensitive recording devices and of their cabling is reduced to a minimum, since, in an advantageous embodiment of the invention, they are not moved along with the moving products. In addition, the advantage results that, preferably, only the deflection or reflection means must be moved, and these can generally be designed to have a much lighter weight than the aforementioned camera tower with several cameras mounted on it. Accordingly, the weight that has to be moved can be designed to be significantly lighter, which entails lower demands for mechanical stability.

It is especially advantageous if the testing is based on recording light beams, with the recording means being in this case one or more cameras that record the reflected or deflected image of the products. In a preferred embodiment of the invention, the products are illuminated at least during the period of observation.

In addition to light beams, any other desired deflectable or reflectable beams or electromagnetic waves, that deliver signals characteristic of the products to be tested, can be used for testing the products, as long as conclusions about the quality of the products can be drawn from them.

It can also be provided that the means for moving the products to be tested include a live ring, so that the motion of the products is circular for at least some distance. In this case it is preferably provided that the deflection or reflection means likewise describes a swivelling motion in such a way that the product moved on the circular path can be observed by the recording means across a predefined section of its path. Of course, it is also possible for the products not to go along a circular path, but rather to go through any desired bends or even a straight path. However, it is preferred that the products are arranged along the peripheral area of a live ring and can be tested one after another. Accordingly, it is provided in a preferred embodiment of the invention that the motion of the products is circular for at least some distance and that the deflection or reflection means can be rotated so that the signals can be deflected or reflected toward the recording means at least during an arc of the circular motion.

It is especially advantageous if the reflection means is a one or two-sided reflecting mirror. It can be provided that several recording means are mounted, with one set of recording means being supplied with light beams or characteristic signals of the products via one side of the mirror, and another set of recording means being supplied via the other side of the mirror.

Any number of media can be considered as a deflecting means to deflect the light beam or signal that hits it from its original direction.

It can be provided that the recording means are cameras that are positioned one above another and/or next to one another. In an arrangement of several cameras one above another, a product can be analyzed in several vertically spaced areas. The arrangement of several cameras spaced along the peripheral direction can serve preferably to test several products simultaneously.

The spatial arrangement of the recording means is optional. The recording means, especially cameras, can be arranged horizontally, vertically, or at an incline. The position of the cameras can be changeable, so that, for example, one camera can be moved back and forth between a horizontal orientation and an inclined orientation. In a further embodiment of the invention, the cameras can be designed to allow adjustment of their height, so that the products can be tested at various levels.

It is especially advantageous if control means are provided that electronically synchronize the motion of the deflection or reflection means to match the motion of the products. Once the testing of one sample is finished, a mirror, for example, that is serving as a reflection means, can be moved back to enable the testing of the next sample. In this embodiment of the invention, these oscillations of the mirror are electronically synchronized with the motion of the products, for example, with the speed of motion of a live ring that holds the products in its peripheral area. Electronic synchronization of this kind has the further advantage that a flexible control of the deflection or reflection means can be performed. For example, the observation phase during which the product is being tested and the restoration phase in which the deflection or reflection means is aimed back toward the next sample can be adjusted optimally to meet specific requirements.

In a further embodiment of the invention, rotary tables can be provided on which the products can be placed. Rotary tables of this kind make it possible to rotate the products themselves around their own axes or around the axis of the rotary table during observation by the recording means. In this way, it is possible to observe or test the products around their entire circumference or at least a partial section thereof.

In addition, rotary tables of this kind can serve to agitate liquids contained in an ampule or small bottle and to stop the rotation of the rotary table as soon as the testing by the recording means begins. In this way, it can be determined whether or not the liquid or gas contains solids, or with what sedimentation speed these solids gravitate toward the bottom of the ampule or small bottle.

In a further embodiment of the present invention, an individual drive mechanism, preferably a synchronous motor, is provided to rotate each rotary table. This kind of embodiment of the present invention brings the advantage that each rotary table can be controlled and programmed independently of the others. In this way, it is conceivable, for example, that some of the rotary tables are made to rotate prior to the testing by the recording means, and others during the testing. If every rotary table has its own drive mechanism, the rotation of the rotary tables can be performed in a manner specific to the samples. If rotation of the rotary tables is not required, it can be stopped, which can be selected individually for each product. The rotary tables can simply fulfill the function of carrying the products placed on them.

It can be provided in principle that the rotary tables or [non-rotary] tables carrying the products serve to cast light onto or transmit light through the products placed upon them.

A further advantage of this kind of embodiment of the invention is that an external rotation means, for making the rotary tables rotate while they are in the area of the rotation means, is not required. Such rotation means of the prior art have a belt drive mechanism that cause the samples to rotate prior to or during the testing by the recording means. The wear that can be observed in this case under some circumstances does not occur in an embodiment of the invention in which each rotary table has its own drive mechanism.

In a preferred embodiment of the present invention, means of illumination are provided to illuminate or transilluminate the products. Whether a sample is illuminated or transilluminated will depend essentially on what properties of the sample, for example, the ampule, or of its contents are supposed to be tested.

Additional details and advantages of the present invention are shown in the design embodiment depicted in the drawings:

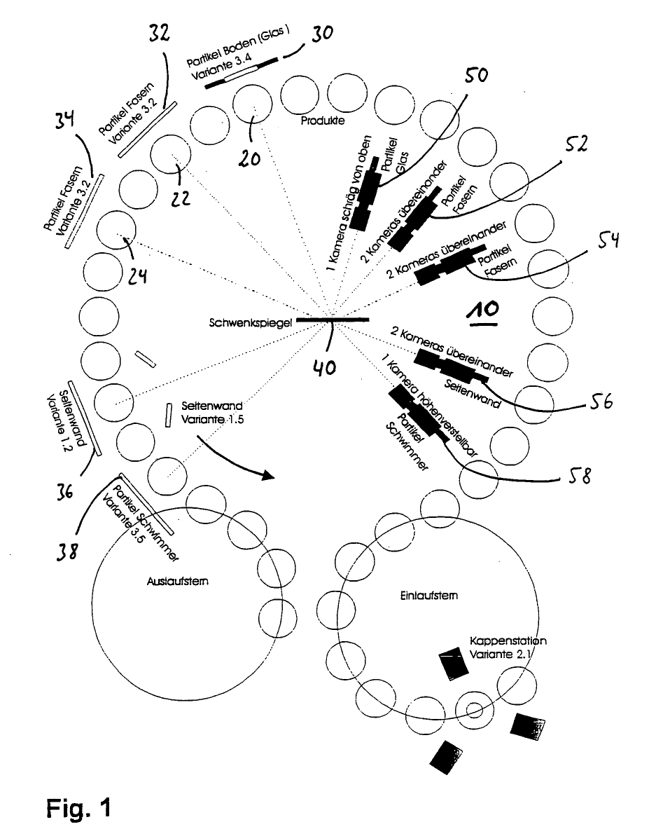

FIG. 1: shows a schematic plan view of a product testing apparatus according to the invention, and

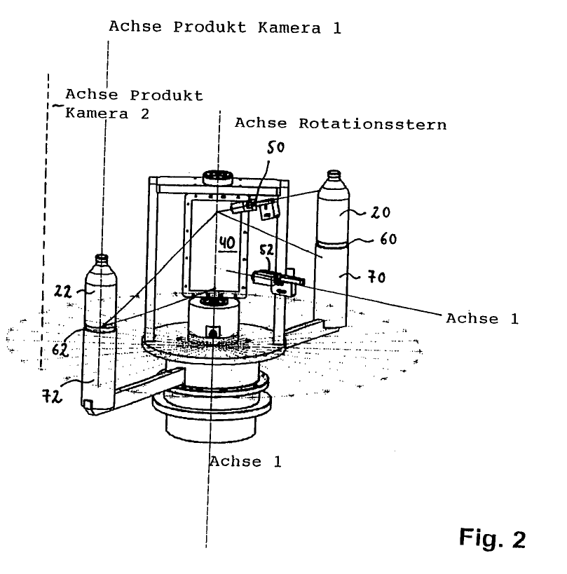

FIG. 2: shows a perspectival view of another embodiment of the invention.

FIG. 1 shows live ring 10 with ampules arranged upon it in a circle. Live ring 10 can be rotated in the direction of the arrow. At its center is mirror 40 that can be swivelled at least over a partial arc, the rotational axis of which is identical to that of live ring 10. Outside of live ring 10 are illumination means 30, 32, 34, 36, and 38. In addition, cameras 50, 52, 54, 56, and 58 are provided, which record the light reflected by mirror 40 and transmit it to an analysis unit.

Ampules located at the position of ampule 20 are illuminated by light screen 30. The light moving through ampules 20 is reflected by mirror 40 and recorded by camera 50. Camera 50 is oriented downward at an incline and serves to determine whether glass particles are found at the bottom of the ampules. During the motion of ampule 20 through the area of illumination means 30, ampule 20 is caused to rotate by a synchronous motor via a rotary table, so that ampule 20 makes at least one full rotation as it moves past light screen 30.

During the circular motion of ampule 20, caused by the rotation of live ring 10, mirror 40 is swivelled so that the light moving through ampule 20 is reflected by the mirror toward camera 50 during a certain arc of the circular path of ampule 20, so that it is possible to test ampule 20 during its motion along the circular path.

After passing through a predefined arc, mirror 40 is swivelled back and the testing of the next ampule is performed, with mirror 40 being swivelled once again so as to convey the light beams or other signals emitted from the ampule toward the camera or cameras. This process is continually repeated, so that mirror 40 describes an oscillating motion, the frequency of which depends on the rotational speed of live ring 10.

Ampules 22 and 24 are located in the area of illumination means 32 and 34. The light moving through these samples is conveyed by swivelling mirror 40 toward cameras 52 and 54. These are two cameras positioned one above the other, so that different areas of ampules 22 and 24 can be tested. In the present embodiment, the presence of particles and fibers in ampules 22 and 24 is being examined.

As can be seen in FIG. 1, the mirror is designed to be reflective on both sides. It enables the light emitted by illumination means 36 and 38 and moving through samples 26 and 28 to be reflected toward cameras 56 and 58. Cameras 56 positioned one above another serve to examine the side wall of ampule 26. As it passes illumination means 36, ampule 26 is rotated in such a way that it makes one full rotation, so that the entire side wall area can be examined using camera 56.

Ampule 38 [sic] is rotated prior to its arrival at light screen 38. This rotational motion is stopped during its movement past light screen 38, in order to test whether particles are present in the solution contained in ampule 38.

Camera 56 is comprised of two cameras positioned one above the other, by means of which different areas of the side wall can be examined. Camera 58 is designed to allow adjustment of its height.

After passing through all testing stations, the ampules leave the testing apparatus via the output whorl and then can be processed further or packaged. The ampules depicted in FIG. 1 pass one after another through the testing stations and in this way can be tested with regard to various criteria using an inspection machine. Due to the presence of several cameras, some of which are spaced one over another and some next to one another, several ampules can be examined at the same time.

As can be seen in FIG. 1, in order to examine the ampules, it is necessary only that the mirror describes the specified movement, that is, that it repeatedly follows the motion of the ampules and then is swivelled back to begin the testing of the next sample. The cameras themselves do not have to undergo such oscillating movement, but rather can be mounted so as not to move during the testing. However, that does not rule out the cameras being height-adjustable, or adjustable in a horizontal direction or in their angle of inclination.

FIG. 2 shows a perspectival view of an embodiment of the invention, in which only two ampules 20, 22 are depicted for the sake of a clear presentation. Ampules 20, 22 are placed on rotary tables 60, 62, which are driven independent of one another by synchronous motors 70, 72. In addition, two cameras 50, 52 are provided that record the light beams reflected by swivelling mirror 40. The functional principle of the apparatus of FIG. 2 is the same as that of the one explained in FIG. 1. The circle depicted with radial lines in FIG. 2 symbolizes the possible positions of the rotary tables with ampules placed upon them.

The presence of drive mechanisms, especially synchronous motors, that can be operated independent of one another, brings the advantage that each ampule 20 can be variously moved and halted according to the desired testing outcome, so that, for example, using the same apparatus in a single work run, tests can be performed as to whether the side wall, the cap, etc. are free of defects or whether particles are present in the sample.

The apparatuses according to FIGS. 1 and 2 have control mechanisms (not depicted) that cause the oscillating motion of mirror 40 to be electronically synchronized with the motion of live ring 10.

Use of inspection machines according to the invention is not restricted to the pharmaceuticals industry, but rather is conceivable for testing any desired products, for example in areas such as the food industry, beverage industry, vitamin industry, or even in the chemical industry.

1. Apparatus for testing products, especially ampules, bottles, and the like, with means for moving the products to be tested, with recording means for recording light beams or other signals characteristic of the products, and with a deflection or reflection means by which the light beams or other signals characteristic of the products can be deflected or reflected toward the recording means over at least a partial section of the motion of the products.

2. Apparatus according to claim 1, characterized in that the recording means are one or more cameras.

3. Apparatus according to claim 1, characterized in that the means for moving the products to be tested include a live ring, so that the motion of the products is circular for at least some distance.

4. Apparatus according to claim 1, characterized in that the motion of the products is circular for at least some distance and that the deflection or reflection means can be rotated so that the light beams or signals can be deflected or reflected toward the recording means at least during an arc of the circular motion.

5. Apparatus according to claim 1, characterized in that the reflection means is a one or two-sided reflecting mirror.

6. Apparatus according to claim 1, characterized in that the recording means are cameras that are positioned one above another and/or next to one another.

7. Apparatus according to claim 1, characterized in that the motion of the products is circular for at least some distance and that several recording means, especially cameras, are provided that are spaced along the peripheral direction of the circular path.

8. Apparatus according to claim 1, characterized in that control means are provided that electronically synchronize the motion of the deflection or reflection means, for example a mirror, to match the motion of the products.

9. Apparatus according to claim 1, characterized in that rotary tables are provided upon which the products are placed.

10. Apparatus according to claim 9, characterized in that an individual drive mechanism, preferably a synchronous motor, is provided to rotate each rotary table.

11. Apparatus according to claim 1, characterized in that means of illumination are provided to illuminate or transilluminate the products.

12. Apparatus according to claim 2, characterized in that the means for moving the products to be tested include a live ring, so that the motion of the products is circular for at least some distance.

13. Apparatus according to claim 2, characterized in that the motion of the products is circular for at least some distance and that the deflection or reflection means can be rotated so that the light beams or signals can be deflected or reflected toward the recording means at least during an arc of the circular motion.

14. Apparatus according to claim 3, characterized in that the motion of the products is circular for at least some distance and that the deflection or reflection means can be rotated so that the light beams or signals can be deflected or reflected toward the recording means at least during an arc of the circular motion.

15. Apparatus according to claim 12, characterized in that the motion of the products is circular for at least some distance and that the deflection or reflection means can be rotated so that the light beams or signals can be deflected or reflected toward the recording means at least during an arc of the circular motion.

16. Apparatus according to claim 2, characterized in that the reflection means is a one or two-sided reflecting mirror.

17. Apparatus according to claim 3, characterized in that the reflection means is a one or two-sided reflecting mirror.

18. Apparatus according to claim 4, characterized in that the reflection means is a one or two-sided reflecting mirror.

19. Apparatus according to claim 12, characterized in that the reflection means is a one or two-sided reflecting mirror.

20. Apparatus according to claim 13, characterized in that the reflection means is a one or two-sided reflecting mirror.
